(19) United States
(12) Patent Application Publication
(10) Pub. No.: US 2006/0040046 A1
(43) Pub. Date: Feb. 23, 2006

(54) Method for manufacturing insulating layer material of wires

(76) Inventor: Jen-Yao Hu, Tainan Hsien (TW)

Correspondence Address: BIRCH STEWART KOLASCH & BIRCH, PO BOX 747, FALLS CHURCH, VA, 22040-0747, US

(21) Appl. No.: 10/921,802

(22) Filed: Aug. 20, 2004

(51) Int. Cl. B05D 5/12; B05D 3/02

(52) U.S. Cl. 427/117; 427/384

(57) ABSTRACT

A method for manufacturing an insulating layer material of wires aims to coat an insulating layer on the surface of a wire. The material being used is a powder thermoplastic material which is blended with a solvent to form a milky thermoplastic coating material. Coat the milky thermoplastic coating material on the surface of the wire. Heat and cure the wire to form the insulation layer on the wire. The method uses thermoplastic material. It is environment-friendly and may be recycled.

### FIELD OF THE INVENTION

The present invention relates to a method of material manufacturing and particularly to a method for manufacturing insulating layer material of wires.

### BACKGROUND OF THE INVENTION

There are many methods to manufacture the insulating layer of the general wires, such as coating, extrusion, taping, powder pressing, and the like. Some of the most commonly used methods are elaborated as follow:

Coating (to cover a liquid material on the wires such as enameled wires) generally includes two processes. First, a drawing process to stretch a desired material (conductor, such as a copper rod) to a wire of a required diameter, and wind the wire to become a bare copper wire and transport to a paint baking counter. Second, proceed an enameling process that includes putting the bare copper wire in an annealing process (as stretching the wire generates stress which must be eliminated through the annealing process by heating to soften the molecular structure and rebuild the bonding force), preparing and dissolving a thermosetting plastic material in a solvent, adding a curing agent to cure the plastic material to become a milky plastic material, placing the bare copper wire in a paint pan, coating evenly the surface of the wire with the milky plastic material, and finally baking and solidifying the coated wire in an oven. The method set forth above can produce the wire at high speed (and a plurality of wires may be manufactured simultaneously) and at a lower cost. However, it also creates problems, notably:

1. The thermosetting plastic material generates chemical reaction when dissolving in the solvent and curing in the curing agent that produces toxic gases. When it is baked in the oven at a high temperature, toxic gases are generated again. It the industry today, environmental protection is a big issue and becomes a fundamental condition of production. The method mentioned above does not conform to the environmental protection concept, thus is not a viable and commendable process. Moreover, when the temperature reaches a certain level, the material becomes brittle and cannot be recycled.

2. In the event that a thicker insulating layer is required, the coating process mentioned above has to be repeated a number of times to reach the thickness needed (for instance, for a wire of a diameter of 10μ, and the coating thickness is 2μ a time, it takes five times of coating to get the finished product). There is a limitation for the insulating layer thickness even by multiple coating. Hence it does not have much practicality.

Another method for forming the insulating layer on the wire is the extrusion pressing. This method heats a selected thermoplastic material (in the form of granules, emulsion or powder according to requirements) to a melting state, then places the wire in a mold of an extruder to form a tube with the wire threading inside, and cools the insulated wire to become the finished product. (The process includes wire supplying, stretching on a tension stand, preheating in a radiant heater, forming the insulating layer by an extruder to shroud the wire, cooling in a cooling machine, processing in a capstan, a spark tester and winding by a winder on a counter). While the extruding method uses the thermoplastic material and does not use the solvent and curing agent as the coating method does, and does not have environmental protection concerns, and the materials may be recycled (about 50%), the equipment used are very bulky and expensive. The materials mostly are selected based on existing specifications produced by chemical plants. Production cost is higher and flexibility is lower. Moreover, the manufacturing equipment has their limitation (can fabricate only one wire of a selected specification at a time). The production speed is lower (extrusion speed is related to the melting flow ratio—MFR of the using materials, the higher the MFR, the faster the extrusion speed becomes, vice versa). Hence it also is not a desirable method.

The taping method is done by covering an insulation tape on the wire to achieve insulation effect. It is simpler, but also has many problems, such as the tape is easily damaged and causes insulation defects, the tape is easily softened or even melted in a high temperature environment, the insulation is not desirable and will generate toxic gases, and is not environment-friendly. Moreover, the wire is wound by the tape layer by layer. Production time is longer and slower. The process is labor intensive and the cost is higher.

The powder pressing method has a counter to extrude power material to become a tube and thread the wire in the tube; after heating, the powders bond together to form an insulating payer of the wire. The process is complicated and difficult. Production speed is lower and the equipment are expensive. The process of heating to bond the powders also produces toxic gases. It is not environment friendly, and is not commendable at the present time.

### SUMMARY OF THE INVENTION

Therefore the primary object of the present invention is to solve the aforesaid problems. The invention aims to provide a method for manufacturing insulating layer material of wires at a lower cost, a faster production speed and is environmental-friendly.

The method according to the invention includes the procedures of:
step 1: prepare a powder thermoplastic material;
step 2: blend the powder material with a solvent to become a milky thermoplastic coating material;
step 3: coat the coating material on the surface of a wire, and cure the material by heating to form an insulation layer of the wire.

The method uses a thermoplastic material which may be recycled and is environment-friendly. The process of coating the material on the surface of the wire, and heating and curing to form the insulation layer on the wire is low cost and may be fabricated at a fast speed to enhance production effectiveness.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the process flow chart of the present invention.

FIG. 2 is a coating process flow of the present invention.

FIG. 3 is a detailed manufacturing process flow of the present invention.

### DETAILED DESCRIPTION OF THE PREFERRED EMBODIMENTS

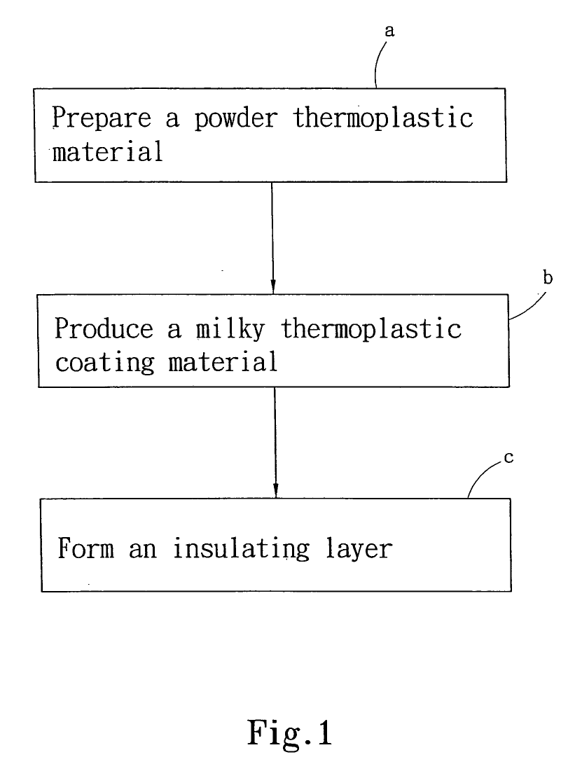

Please refer to FIG. 1 for the process flow of the invention. The method for manufacturing an insulating layer of wires according to the invention includes the procedures as follow:
step a: prepare a power thermoplastic material (blended according to the bonding ability to the selected wire, melting temperature, etc.) or thermoplastic chips (also blended according to the bonding ability to the selected wire, melting temperature, etc. such as Teflon (PTFE) or PVDF) formed by grinding;
step b: blend the powder thermoplastic material with a solvent (an activator and water) to become a milky thermoplastic coating material; the ratio of the activator and water correspond to the solid content ratio of the thermoplastic material (the solid content ratio of the powder thermoplastic coating material is 10% to 90%, the activator and water ratio is 10% to 90%); and
step c: coat the milky thermoplastic coating material on the surface of a selected wire, and cure the material by heating to form an insulation layer of the wire.

By means of the method set forth above, the granular thermoplastic material has desired characteristics (such as thermoplastic property which is a characteristic of high molecular polymers that may be softened when heated to a certain temperature and result in change of the form or shape) that do not require to add other chemical agents (such as solvent and curing agent used in the conventional coating method to generate chemical reactions). It may be recycled and is environment-friendly. Moreover, the final step of the method is coating the material on the surface of the wire and curing the material by heating to form the insulating layer. Production speed is faster and simpler, and production cost is lower.

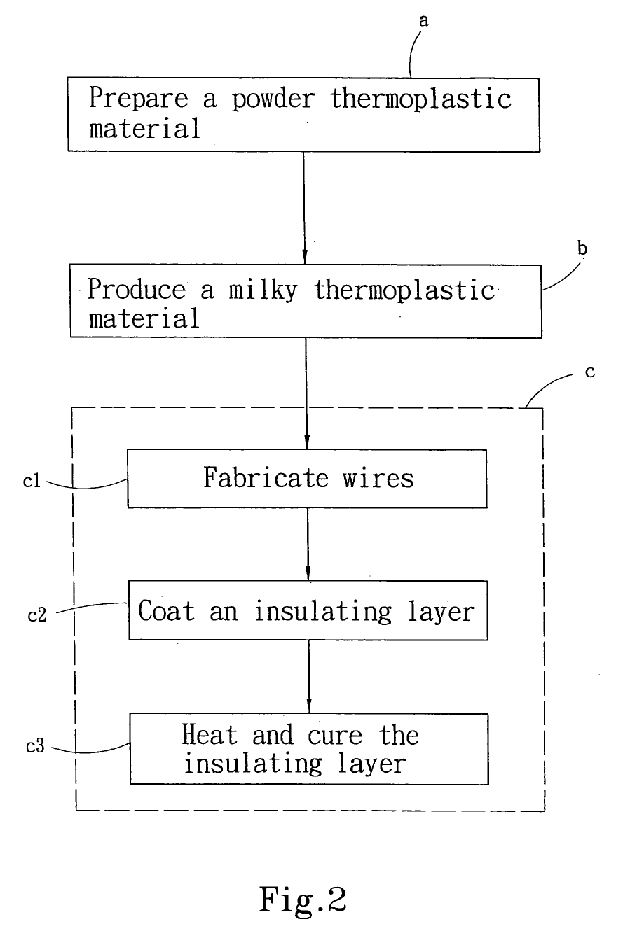

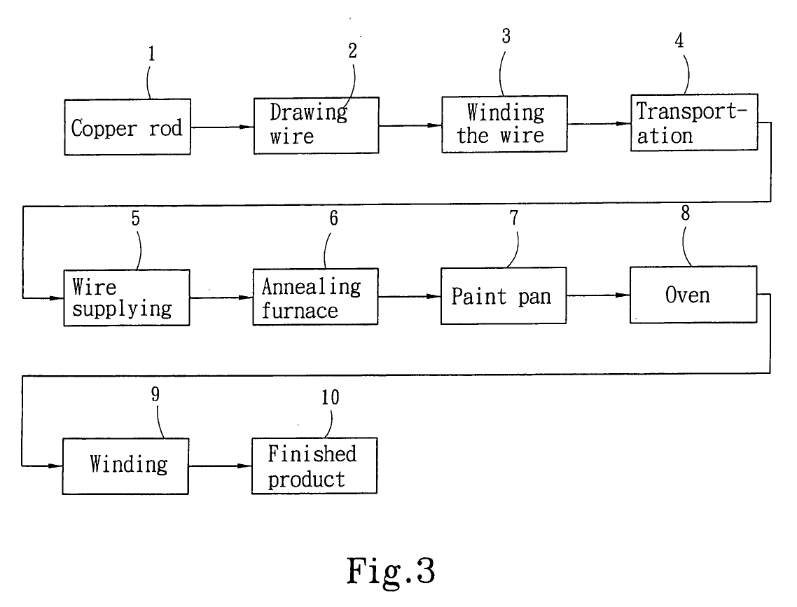

Refer to FIGS. 2 and 3 for the coating process and detailed manufacturing process of the invention. The coating process includes the procedures of:
c1. Wire fabrication step: prepare a metal rod (such as a copper rod 1); stretch the metal rod by drawing 2 according to the required wire diameter (for instance, if the required wire diameter is 0.5 mm, the original copper rod of 8 mm diameter may be drawn once to the diameter of 2.6 mm, drawn twice to the diameter of 1.0 mm, and drawn one more time to the required diameter of 0.5 mm); wind the wire through a winder in a spooler 3, the wound wire is transported 4, supplied with wire material 5 and sent to an annealing furnace 6 to perform pre-annealing process (the annealing furnace 6 is used to perform annealing process to eliminate the restoring stress of the wire generated in the drawing process 2, and set the wire in a desired form), and obtain a required wire for coating;
c2. Coat an insulating layer: pour the milky thermoplastic material in a paint pan 7; run the wire to be coated in the paint pan 7 to coat evenly a layer of the milky thermoplastic material on the outer surface of the wire;
c3. Cure by heating: the wire coated with a layer of the milky thermoplastic material is placed in an oven 8 for heating to cure the milky thermoplastic material to become an insulating layer of the wire; finally wind the wire through a wind up 9 process to become a finished product 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing an insulating layer material of wires to coat the material on the surface of a wire to form an insulating layer; the method comprising the steps of:
step 1: preparing a powder thermoplastic material;
step 2: blending the powder thermoplastic material with a solvent to become a milky thermoplastic coating material; and
step 3: coating the milky thermoplastic coating material on the surface of a wire, and curing the material by heating to form an insulation layer of the wire.

2. The method of claim 1, wherein the powder thermoplastic material is obtained by blending according required conditions which include bonding ability to the wire and the melting temperature.

3. The method of claim 1, wherein the powder thermoplastic material is obtained by grinding a granular thermoplastic material.

4. The method of claim 3, wherein the granular thermoplastic material is obtained by blending according required conditions which include bonding ability to the wire and the melting temperature.

5. The method of claim 3, wherein the granular thermoplastic material is Teflon (PTFE) or PVDF.

6. The method of claim 1, wherein the solvent is an activator and water.

7. The method of claim 6, wherein the ratio of the activator and the water being added corresponds to the solid content ratio of the power thermoplastic material.

8. The method of claim 7, wherein the solid content ratio of the power thermoplastic material ranges from 10% to 90%, and the ratio of the activator and the water ranges from 10% to 90%.

9. The method of claim 1, wherein the insulating layer of the wire is coated through a coating process which includes the steps of:
fabricating the wire: drawing a metal rod to form the wire according to a required wire diameter, winding the wire and annealing the wire to obtained the wire to be coated;
coating the insulating layer: pouring the milky thermoplastic material into a paint pan, running the wired to be coated in the paint pan to evenly coat the milky thermoplastic material on the outer surface of the wire; and
heating and curing: placing the wire coated with the milky thermoplastic material in an oven to be heated and cured to form the insulating layer on the wire.
